(19) United States
(12) Patent Application Publication
(10) Pub. No.: US 2024/0123647 A1
(43) Pub. Date: Apr. 18, 2024

(54) REUSABLE FIXTURE ASSEMBLY FOR SLITTING A WORKPIECE INTO A SERPENTINE BODY

(71) Applicant: CORNING INCORPORATED, Corning, NY (US)

(72) Inventors: Song Lyu, Painted Post, NY (US); Min Shen, Horseheads, NY (US)

(21) Appl. No.: 18/376,620

(22) Filed: Oct. 4, 2023

Related U.S. Application Data
(60) Provisional application No. 63/416,660, filed on Oct. 17, 2022.

(51) Int. Cl. B26F 3/00

(52) U.S. Cl. CPC B26F 3/004

(57) ABSTRACT

A fixture assembly for slitting a workpiece into a serpentine body, a cutting system having a fixture assembly, and a method of forming a serpentine body. The fixture assembly includes a patterned support section that has a plurality of support slats interspaced with gaps. A holder plate has an opening configured to receive the workpiece and positioned atop the patterned support section such that intended cutting locations in the workpiece are positioned directly above the gaps in the patterned support section and the slats are positioned directly below uncut portions of the serpentine body after cutting the workpiece.

### CROSS-REFERENCE TO RELATED APPLICATION

This application claims the benefit of priority under 35 U.S.C. § 119 of U.S. Provisional Application Ser. No. 63/416,660 filed on Oct. 17, 2022, the content of which is relied upon and incorporated herein by reference in its entirety.

### FIELD

This disclosure relates to water jet cutting fixtures and more specifically to water jet cutting fixtures for forming a plurality of cuts into a workpiece, and a method of manufacturing a serpentine resistance heater disk by forming a plurality of slits into the heater disk.

### BACKGROUND

Electrical resistance heaters are one option to provide supplemental heat into an internal combustion engine's exhaust aftertreatment system for enabling fast light-off of a downstream catalytically-loaded component (e.g., catalytic converter) of the exhaust aftertreatment system. One type of electrical resistance heater employs a series of slits extending alternatingly into the heater from opposite sides of the body of the heater to provide a serpentine electrical path through the heater body that increases the resistance across the heater and thereby enables the heater to generate heat via Joule heating when a voltage is applied to the heater. The slits that define the serpentine pattern must be formed into the heater body during manufacture of the serpentine resistance heaters, which can add complexity and cost to the manufacturing process.

### SUMMARY

Disclosed herein are fixture assemblies for slitting a workpiece into a serpentine body. In embodiments, a fixture assembly comprises a patterned support section comprising a plurality of support slats interspaced with gaps; and a holder plate comprising an opening configured to receive the workpiece and positioned atop the patterned support section such that intended cutting locations in the workpiece are positioned directly above the gaps in the patterned support section and the slats are positioned directly below uncut portions of the serpentine body after cutting the workpiece.

In embodiments, the patterned support section is part of a support plate positioned below the holder plate.

In embodiments, the support plate is secured to the holder plate via one or more fasteners.

In embodiments, the fixture assembly further comprises a removable support element on which the patterned support section is located and the support plate comprises a receptacle shaped and sized to removably receive the removable support element therein.

In embodiments, at least one outer edge of the removable support element has a lip that rests on a corresponding lip of a corresponding edge of the receptacle.

In embodiments, one of the holder plate and the support plate comprises one or more calibration pins and the other of the holder plate and the support plate comprises one or more calibration holes, each calibration hole corresponding to and arranged to receiving one of the calibration pins.

In embodiments, the fixture assembly comprise a plurality of the calibration pins and a plurality of the calibration holes, wherein the calibration pins are located a fixed distance from each other and the calibration holes are also located the fixed distance from each other.

In embodiments, the support plate comprises the one or more calibration pins and the holder plate comprises the one or more calibration holes.

In embodiments, the workpiece has a honeycomb configuration that comprises an array of intersecting walls that define channels extending axially therethrough.

In embodiments, the holder plate comprises a plurality of segments that are movable with respect to each other, and the opening in the holder plate is formed together by the plurality of segments such that relative movement of the segments causes change in shape or size of the opening.

In embodiments, the fixture assembly further comprises one or more positioning mechanisms between one or more adjacent pairs of the segments to control relative movement therebetween.

In embodiments, each positioning mechanism comprises a threaded rod connected between the corresponding adjacent pair of segments and that causes relative movement between the adjacent pair of segments when the threaded rod is rotated.

In embodiments, the fixture assembly further comprises one or more locking nuts to fix the relative position of the adjacent segments by preventing rotation of the threaded rod when tightened.

In embodiments, the holder plate comprises at least one clamp that is selectively engagable with the workpiece to prevent vertical movement of the workpiece when the workpiece is positioned in the opening.

In embodiments, the holder plate comprises one or more grippers that are radially movable into and out of the opening to engage against an outer periphery of the workpiece when the workpiece is in the opening.

In embodiments, wherein the support plate comprises a trench defining a plurality of fastener locations about the outer periphery of the workpiece, that enable angular alignment of the holder plate to the support plate.

Also disclosed herein are cutting systems. In embodiments, a cutting system comprises a fixture assembly according to an embodiment of any of the preceding paragraphs positioned with respect to a water jet cutting tool for enabling the water jet cutting tool to slit the workpiece held by the fixture assembly.

Also disclosed herein are methods for forming a serpentine body with a water jet cutting system. In embodiments, a method comprises positioning a workpiece in an opening of a holder plate and on top of a patterned support section that comprises a plurality of support slats interspaced with gaps such that intended cutting locations for creating slits in the workpiece are positioned directly above the gaps in the patterned support section; cutting a plurality of slits through the workpiece along the intended cutting locations with a water jet cutting tool of the water jet cutting system without cutting into the patterned support section to create the serpentine body from the workpiece, wherein the slats are positioned directly below uncut portions of the serpentine body after the workpiece is cut.

In embodiments, the method further comprises inserting a removable support element that comprises the patterned support section into a receptacle of a support plate, wherein the holder plate is secured atop the support plate.

In embodiments, the method further comprises affixing the support plate to the water jet cutting system, wherein the support plate comprises a calibration pin extending therefrom; aligning the holder plate with respect to the support plate by inserting the calibration pin through a calibration hole in the holder plate when the holder plate is positioned atop the support plate; calibrating a reference coordinate for the water jet cutting system with respect to the calibration pin; and determining a location of one or more of the opening, the workpiece, the intended cutting locations, the slats, or the gaps based on the reference coordinate.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic diagram of a water jet cutting system according to embodiments disclosed herein.

FIG. 2 schematically illustrates a top view of a serpentine heater body having a honeycomb configuration with an enlarged view showing intersecting walls and channels of the honeycomb configuration and a portion of a slit defining the serpentine pattern of the heater body.

FIG. 3 is an exploded view of a fixture assembly for cutting a workpiece according to embodiments disclosed herein.

FIG. 4A is a top view of a patterned support section of a support plate of a fixture assembly disclosed herein showing alignment with respect to an intended cutting locations for forming slits in a workpiece shown in dashed lines.

FIG. 4B is a top view of a patterned support section of a support plate of a fixture assembly disclosed herein with a holder plate positioned atop the support plate with a portion of the patterned support section positioned below an opening in the holder plate.

FIG. 5 is an exploded view of a fixture assembly for cutting a workpiece according to embodiments disclosed herein.

FIG. 6 is a top view of a holder plate comprising positioning mechanisms that enable variable adjustment of an opening in the holder plate that enables the opening to accommodate workpieces of variably shapes or sizes.

FIG. 7 illustrates a top view of a holder plate and a support plate of a fixture assembly according to embodiments disclosed herein that comprise an alignment feature to assist in positional calibration of the cutting system used with the fixture assembly.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Serpentine bodies can be used in a variety of applications, such as resistance heater bodies for providing supplemental heat in an exhaust aftertreatment system for an internal combustion engine. The formation of a serpentine body requires a plurality of slits in the body that define the serpentine patterned by isolating, breaking, severing, or otherwise preventing electrical connection between portions of the body on opposite sides of the slits. In some manufacturing techniques the slits can be formed directly during manufacture of the body itself, such as via three-dimensional printing. However, if a body is instead extruded or formed in some other manner, it is more practical to form the slits in a separate manufacturing step after formation (e.g., extrusion) of the body. For example, extrusion may be used to form a honeycomb body, while weaving may be used to form a mesh or screen, or a foaming process may be used to form a foamed body. In any such case, the honeycomb, mesh, screen, or foam workpiece will need to be slit to create a serpentine body therefrom.

A common step during water jet cutting is to make a one-time use sacrificial fixture to hold the part need to be cut. However, the creation of sacrificial fixtures is too costly and time consuming to be not practical for the industrial manufacture of individual serpentine bodies. However, support of the workpiece during slitting to create serpentine bodies is necessary since the uncut segments of the serpentine body extending between each adjacent pair of slits will sag, droop, or bend after slitting, and be increasingly prone to vibration as more slits are made in the workpiece.

In various embodiments, the disclosed embodiments provide for fixtures and methods for facilitating the slitting of workpieces as part of a process for manufacturing serpentine bodies, such as those used as resistance heaters. Advantageously, the embodiments disclosed herein provide for reusable fixtures, as well as those that can be variably adjusted in size to accommodate a variety of different sized or shaped workpieces. Additionally, the embodiments disclosed herein advantageously provide sufficient support to the serpentine segments of the workpiece as the workpiece is slitted to ensure consistent clean cuts are made in the workpiece during the entire serpentine slitting process by reducing or eliminating sagging, drooping, bending, and/or vibration of the segments of the workpiece throughout the entire slitting process.

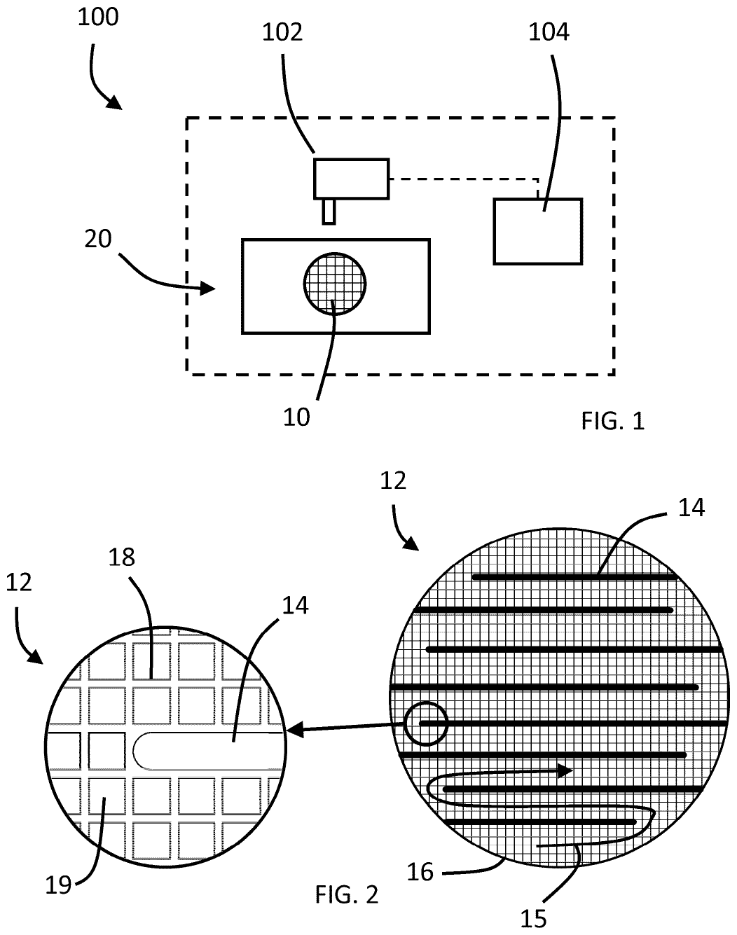

FIG. 1 schematically illustrates a cutting system 100 for making a number of cuts into a workpiece 10 that is held in place by a fixture assembly 20 during the cutting operation. In particular as described herein, the workpiece 10 can comprise a body having a plurality of flow passages axially therethrough, such as a honeycomb configuration, or other configuration having axial flow paths therethrough, such as a mesh, screen, or foamed body that enables the body to be used as a resistance heater as described herein. If a honeycomb configuration is utilized, the workpiece 10 can be manufactured, for example, by extrusion of a metallic particle-containing mixture into a green metal body that is cut to a desired length and then fired to sinter the metal particles together, and/or by extrusion of a ceramic green body that is then infiltrated with metallic particles.

FIG. 2 shows one example of the workpiece 10 after cutting to form a serpentine body 12, e.g., a serpentine body for a resistance heater. That is, the serpentine pattern of the body 12 is defined by a plurality of slits 14 alternatingly extending into the body 12 from opposite sides of an outer periphery 16 of the body 12. As described further herein, the body 12 can form a heating element for an electrical resistance heater, where the slits 14 electrically isolate, insulate, disconnect, and/or sever portions of the serpentine body 12 on opposite sides of the slits 14 to define a serpentine electric current-carrying path 15 when electrical voltage is applied to the body 12, such as via a pair of electrodes connected at opposite ends of the serpentine path 15.

As best seen in the enlarged portion of FIG. 2, the serpentine body 12 comprises a honeycomb configuration that comprises an array of intersecting walls 18 that define channels 19 extending therethrough. Accordingly, the channels 19 provide openings that enable flow of fluid (e.g., exhaust gas) axially through the body 12 while the intersecting walls 20 comprise an electrically conductive material, such as a metal or metallic alloy, that enables electrical conduction through the serpentine path 15. In this way, an electrical voltage applied to the body 12 can result in resistance heating of the body 12 as the electrical current travels through the serpentine path 15, while the channels 19 enable the fluid flow passing through the body 12 to undergo heat exchange with the heater body, thereby heating the fluid flow. For example, the heater body 12 can be used to provide supplemental heat to the fluid flow, e.g., an engine exhaust flow, to heat up components downstream of the heater, such as a catalyst-loaded substrate of a catalytic converter. As noted above, configurations other than honeycomb configurations can be used that provide axial fluid flow through the body 12 while electrical conduction occurs through the serpentine path can be used, such as a screen, mesh, or foam material for the body 12 that has been cut as described herein to form the slits 14.

Referring back to FIG. 1, the cutting system 100 can comprise a cutting tool 102, such as a water jet cutter, connected to a controller 104 that comprises requisite software and hardware for controlling operation of the cutting tool 102. The cutting system 100 can comprise a camera or other vision sensor to determine a position of the cutting tool 102 with respect to the workpiece 10, one or more actuators for controlling movement of the cutting tool 102 and/or the workpiece 10 relative to each other. For example, the controller 104 can comprise software suitable to enable the controller 104 to receive image signals from a camera, determine a location of the cutting tool 102 and/or workpiece 10 based on the image signals, and then control movement of the cutting tool 102 to move the cutting tool 102 along a cutting path defined in instructions stored in memory of the controller 104. For example, the cutting path can correspond to the locations of the slits 14 to be made in the workpiece 10 in order to form the serpentine body 12.

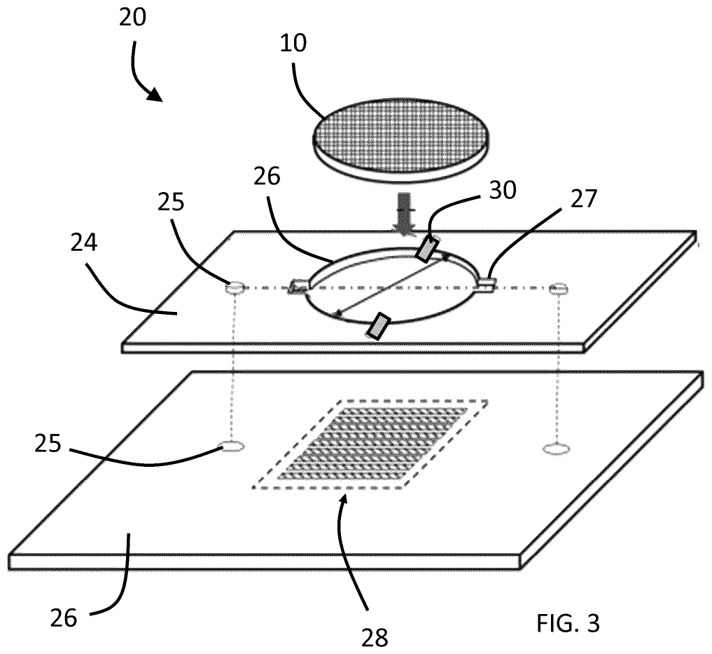

FIG. 3 shows an embodiment of the fixture assembly 20 that comprises a holder plate 22 and a support plate 24 that can be secured together to both hold and support the workpiece 10 during cutting by the cutting system 100. For example, the holder plate 22 can be bolted or otherwise fastened to the support plate 24 at corresponding fastener holes 25, through which and/or into which a bolt or other fastener can be inserted. Each of the holder plate 22 and the support plate 24 can be a suitable durable material, such as aluminum, steel, or other metal, while other materials such as a durable plastic can be utilized.

The holder plate 22 comprises an opening 26 that is configured to receive the workpiece 10 therein. The opening 26 can be shaped and sized to complementarily receive the workpiece 10 therein. The opening 26 can comprise cutouts 27 that facilitate gripping of the sides of the workpiece 10 (e.g., by a worker, tool, or robotic gripping implement) in order to facilitate placement of the workpiece 10 into the opening 26 and/or removal of the workpiece 10 from the opening 26. As described in more detail below, the support plate 24 comprises a patterned support section 28 positioned below the opening 26 that provides support to the underside of the workpiece 10 as the workpiece 10 is cut by the system 100. As described in more detail below, the patterned support section 28 comprises a pattern that complementarily corresponds to the intended cutting pattern to be made into the workpiece 10.

The holder plate 22 can further optionally comprise one or more clamps 30 that are movably or releasably engageable with the top side of the workpiece 10 when the workpiece 10 is positioned in the opening 26, such as by pinning the workpiece 10 against the support plate 22 or otherwise preventing vertical movement of the workpiece 10 during cutting. In this way, the holder plate 22 provides support to prevent lateral or horizontal movement of the workpiece 10, while the support 24 provides a surface upon which the workpiece 10 rests, and optionally the clamps 30 prevent vertical movement out of the opening 26, to securely hold the workpiece 10 in place during cutting.

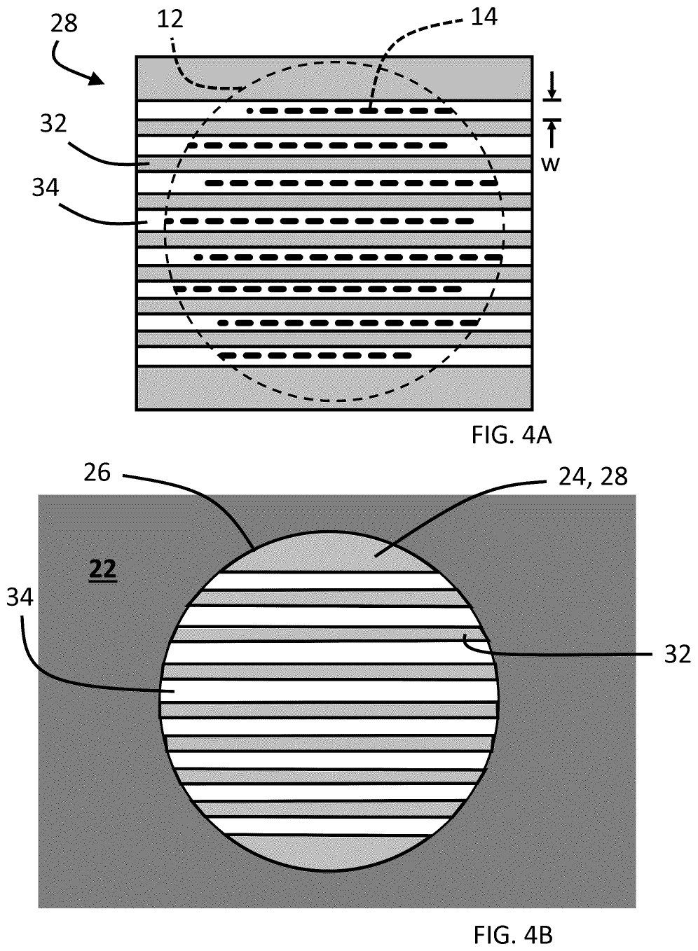

An example of the patterned support section 28 is shown in more detail in FIG. 4A. In this embodiment, the patterned support section 28 comprises a plurality of support slats 32 (shown shaded in gray) alternatingly interspaced with a plurality of gaps 34 (shown as unshaded white areas). The slats 32 and the gaps 34 can be arranged in a pattern that is complementary with respect to the intended cutting pattern for the workpiece 10. For example, the slats 32 comprise segments of solid material that support the uncut portions of the workpiece 10 (e.g., the elongate segments of the body 12 that extend between adjacent pairs of the slits 14), while the gaps 34 comprise openings or slots that permit the cutting operation to commence without damage to the patterned support section 28 that lies under the workpiece 10 during cutting.

For example, the outline of the serpentine body 12 and slits 14 are shown in dashed lines overlaid on top of the patterned support segment 28 in FIG. 4A. Accordingly, when creating the serpentine body 12 from the workpiece 10, the intended locations of slits 14 can be positioned directly over the gaps 34 such that the cutting implement, e.g., a water jet, can create the slits 14 in the workpiece 10 during creation of the serpentine body 12 without damaging the support section 28. Likewise, the slats 32 of the support section 28 lie under each of the uncut segments of the serpentine body 12 in order to continue to fully support all portions serpentine body 12 as the plurality of slits 14 are formed. Without the slats 32, unsupported segments of the workpiece 10 would tend to sag, droop, or bend downward as the slits 14 are created.

To facilitate prevention of the support section 28, the gaps 34 can have a width w (dimension between adjacent slats 32) that is at least as wide as the corresponding width of the slits 14 intended to be cut into the workpiece 10 during formation of the serpentine body 12. In some embodiments, the gaps 34 are wider than the width of the slits 14, such as at least 50% wider than the slits 14, at least twice as wide as the slits 14, or even at least three times as wide as the slits 14. In this way, the gaps 34 prevent inadvertently cutting through the support section 28 even if the cutting operation is not perfectly straight, if the workpiece 10 vibrates or slightly moves during cutting, and/or to accommodate a variable cutting width of the cutting system 100 during the cutting operation (e.g., a water jet cutting operation may not create perfectly straight cuts and/or cuts that are exactly the same width from top to bottom of the cut).

FIG. 4B illustrates a top view of the portion of the fixture assembly 20 proximate to the opening 26 after the holder plate 22 (shown in a darker gray) has been positioned over the support plate 24 (shown in a lighter gray). Portions of the slats 32 and gaps 34 can be seen through the opening 26 in the holder plate 22, where the workpiece 10 is intended to be positioned (again, as shown in dashed lines FIG. 4A).

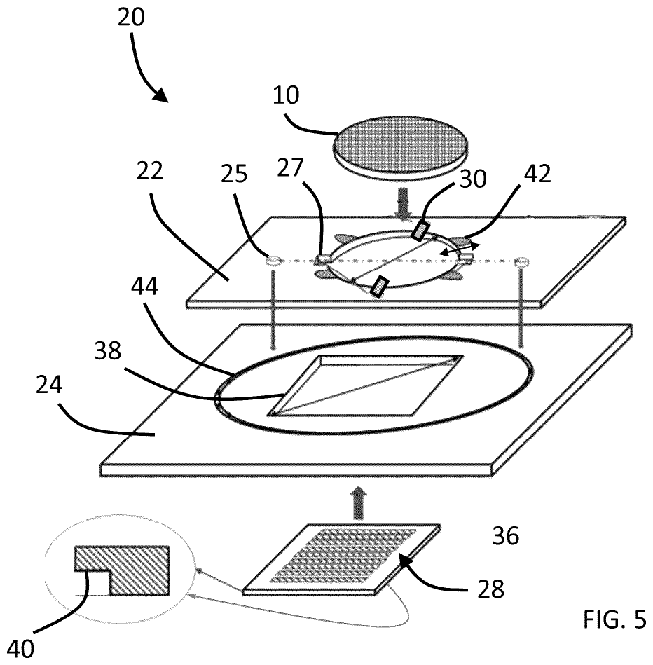

FIG. 5 illustrates an embodiment for the fixture assembly 20 in which different cutting patterns can be accommodated, e.g., to create serpentine bodies having a different number, orientation, and configuration for the slits 14. More particularly, in the embodiment of FIG. 5, the patterned support section 28 can be located on a removable support element 36 that is separate from the support plate 24. In this way, different support sections 28 comprising different arrangements of the slats 32 and the gaps 34 can be selectively and removably used by inserting different removable support elements 36 into a corresponding receptacle 38 in the support plate 24. For example, all of the removable support elements 36 can have the same size and shape so as to be received in the receptacle 38, while having different configurations of slats 32 and gaps 34 that accommodate different cutting patterns.

To assist in holding the support sections 28 in place in the receptacle 38, one or more outer edges of the removable support element 36 can have a lip, shelf, or flange 40 as shown in the enlarged portion of FIG. 5, which overlaps a corresponding lip, shelf, or flange on a corresponding edge of the receptacle 38. In particular, at least two such edges can comprise a pair of the lips 40, such an opposing pair of the edges, in order to enable the removable support element to be fully supported within the receptacle 38. In embodiments, all edges of the removable support element comprise one of the lips 40.

In the embodiment of FIG. 5, the opening 26 has also been fitted with lateral grippers 42, four of which are illustrated but any number can be used. The grippers 42 are movable radially into and out of the opening 26 as illustrated by the double headed arrow. The grippers 42 can be actuated by a screw, ratchet, rail, or slide that enables the grippers to be locked at various radial positions. In this way, the grippers 42 can be used to engage laterally against and provide lateral support to the outer periphery 16 of the workpiece 10 and/or serpentine body 12 that are of a variety of different sizes. In other words, even if the workpiece 10 is radially smaller than the opening 26, the grippers 42 can be moved radially inwardly into engagement with the workpiece 10 to provide lateral support during cutting. For relatively larger sized workpieces, the grippers 42 can be radially retracted. Additionally, the grippers 42 can be useful for securing workpieces that are not the same shape as the opening 26, such as square, rectangular, triangular, or oval workpieces when the opening 26 is round.

Additionally, in the embodiment of FIG. 5, the support plate 24 is provided with a fastening trench 44 that circumscribes the area of the support section 28 as opposed to the fastener holes 25. For example, the fastening trench 44 can be a channel or groove that extends partially into the support plate 24, wherein a plurality of holes at various locations about the trench are provided at the bottom of the trench 44 that extend entirely through the support plate 24. In this way, fasteners, such as bolts, inserted through the fastener holes 25 in the holder plate 22 can be arranged at various locations in the trench 44 to enable some degree of rotational alignment to be achieved between the holder plate 22 and the support plate 24. The rotational alignment of the holder plate 22 and the support plate 24 can be useful, for example, to assist in aligning the workpiece 10 with respect to the cutting tool 102 in order to ensure the intended cutting pattern is positioned properly on the workpiece 10.

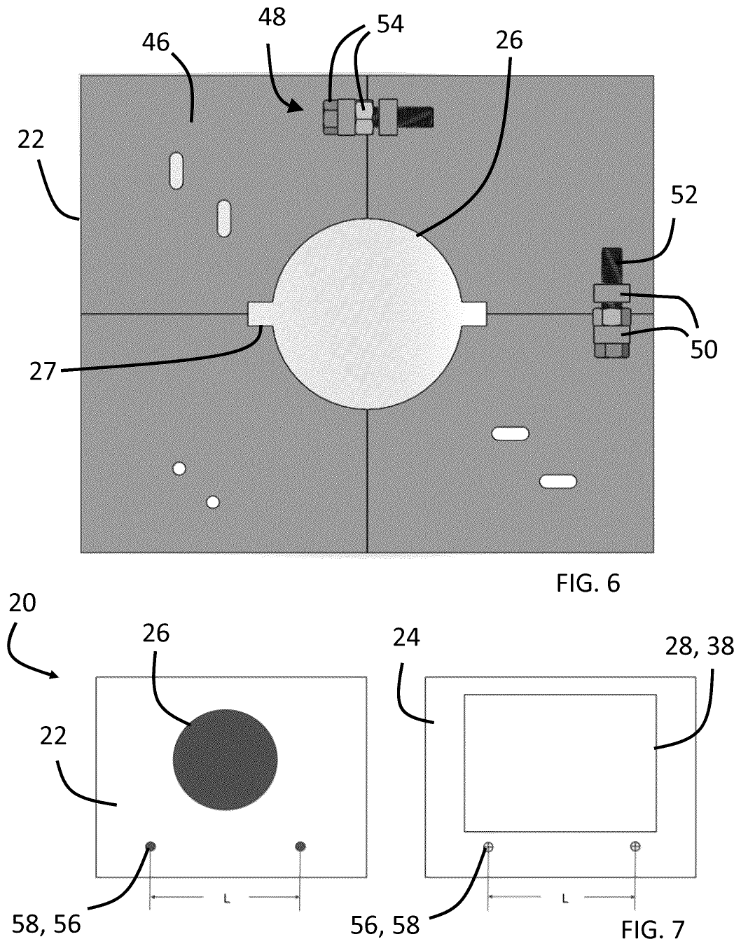

FIG. 6, illustrates another embodiment of the fixture assembly 20 in which the holder plate 22 comprises a plurality of segments 46 that together form the opening 26 when arranged together and that are movable to at least some limited degree with respect to each other. In this way, by moving the segments 46 with respect to each other, the shape and size of the opening 26 can be altered (e.g., enlarged by moving the segments 46 away from each other and/or restricted by moving the segments 46 closer to each other). In FIG. 6, the holder plate 24 comprises four of the segments 46 but in other embodiments any other number of at least two of the segments 46 can be used.

When the holder plate 22 comprises multiple of the segments 46, the segments 46 can be moved relative to each other by positioning mechanisms 48. For example, in the embodiment of FIG. 6, the positioning mechanisms comprise a pair of tabs 50 extending from each of an adjacent pair of the segments 46 that are connected together by a threaded rod 52. Rotation of the threaded rod 52 in one direction can pull the connected pair of the segments 46 together, while rotation in the opposite direction will push the segments 46 apart. The positioning mechanisms 48 can comprise other arrangements, such as ratchets or a rack and pinion. The positioning mechanisms 48 may also include locking components to fix the relative position of the segments 46, such as a pair of nuts 54 on the threaded rod that can be tightened to clamped on the tabs 50 to lock the threaded rod 52 in place until the nuts 54 are loosened. Any number of adjacent pairs of the segments 46 can be equipped with positioning mechanisms 48. For example, in FIG. 6 there are two of the positioning mechanisms 48, with a first positioning mechanism enabling relative movement of two of the segments 46 in the left-to-right direction in FIG. 6, and a second positioning mechanism enabling relative movement in the up-to-down direction in FIG. 6. In this way, the size and shape of the opening 26 can be set to accommodate non-circularity in workpieces, non-round shapes, and/or workpieces of a range of different sizes.

FIG. 7 illustrates another embodiment for the fixture assembly 20 in which the holder plate 22 and the support plate 24 comprise one or more positional reference calibration features that enable the location of one or more of the holder plate 22, the opening 26, the slats 32, the gaps 34, the support 24, the workpiece 10, and/or the intended cutting locations in the workpiece 10 to be determined with respect to each other. In the embodiment of FIG. 7, the positional reference calibration features comprise a pair of pins 56 that correspond to a pair of holes 58. For example, the pins 56 can extend from the support plate 24 through the holes 58 formed in the holder plate 22, or down from the holder plate 22 through the holes 58 formed in the support plate 24.

In either case, the pins 56 and the holes 58 are a fixed distance L from each other. For example, as described above, the cutting system 100 can comprise a camera or vision system that is used to determine a location of the workpiece 10 to assist in cutting. When using such a camera or vision system, the pins 56 and/or holes 58 can be used as a reference location or coordinate that enables the cutting system 100 to quickly determine the location of components of the fixture assembly 20, and therefore of the workpiece 10, based on calibration with respect to the reference location set by the calibration pins 56. In this way, the very time-consuming step of recalibrating and aligning reference points with the cutting tool 102 for each and every workpiece that needs to be slitted is avoided. For example, the support plate 24 can first be fixed with respect to the cutting system 100 and the water jet cutting tool can be aligned with a center of one of the pins 56 to establish the reference coordinate, such as a single origin point and/or with as a line passing through the centers of both pins for orientation of a reference coordinate axis (e.g., the x-axis).

Since the opening 26 and the receptacle 38 are at a fixed locations relative to the pins 56 and holes 58 and the workpiece 10 is positioned within the opening 26, the location of the workpiece 10 is also accurately set with respect to the cutting pattern. Advantageously, this alignment of the cutting system 100 to the support plate 24 only needs to be done once at the beginning of a cutting operation, with the holder plate 22 and/or removable support elements 38 able to be swapped out any number of times for cutting any number of workpieces without losing this alignment, since the holder plate 22 and the support section 28 are automatically aligned to the support plate 24 via the pins 56 and holes 58 when reinstalled in the fixture assembly 20.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A fixture assembly for slitting a workpiece into a serpentine body, comprising:
a patterned support section comprising a plurality of support slats interspaced with gaps; and
a holder plate comprising an opening configured to receive the workpiece and positioned atop the patterned support section such that intended cutting locations in the workpiece are positioned directly above the gaps in the patterned support section and the slats are positioned directly below uncut portions of the serpentine body after cutting the workpiece.

2. The fixture assembly of claim 1, wherein the patterned support section is part of a support plate positioned below the holder plate.

3. The fixture assembly of claim 2, wherein the support plate is secured to the holder plate via one or more fasteners.

4. The fixture assembly of claim 2, further comprising a removable support element on which the patterned support section is located and the support plate comprises a receptacle shaped and sized to removably receive the removable support element therein.

5. The fixture assembly of claim 4, wherein at least one outer edge of the removable support element has a lip that rests on a corresponding lip of a corresponding edge of the receptacle.

6. The fixture assembly of claim 2, wherein one of the holder plate and the support plate comprises one or more calibration pins and the other of the holder plate and the support plate comprises one or more calibration holes, each calibration hole corresponding to and arranged to receiving one of the calibration pins.

7. The fixture assembly of claim 6, comprising a plurality of the calibration pins and a plurality of the calibration holes, wherein the calibration pins are located a fixed distance from each other and the calibration holes are also located the fixed distance from each other.

8. The fixture assembly of claim 6, wherein the support plate comprises the one or more calibration pins and the holder plate comprises the one or more calibration holes.

9. The fixture assembly of claim 1, wherein the workpiece has a honeycomb configuration that comprises an array of intersecting walls that define channels extending axially therethrough.

10. The fixture assembly of claim 1, wherein the holder plate comprises a plurality of segments that are movable with respect to each other, and the opening in the holder plate is formed together by the plurality of segments such that relative movement of the segments causes change in shape or size of the opening.

11. The fixture assembly of claim 10, further comprising one or more positioning mechanisms between one or more adjacent pairs of the segments to control relative movement therebetween.

12. The fixture assembly of claim 11, wherein each positioning mechanism comprises a threaded rod connected between the corresponding adjacent pair of segments and that causes relative movement between the adjacent pair of segments when the threaded rod is rotated.

13. The fixture assembly of claim 12, further comprising one or more locking nuts to fix the relative position of the adjacent segments by preventing rotation of the threaded rod when tightened.

14. The fixture assembly of claim 1, wherein the holder plate comprises at least one clamp that is selectively engageable with the workpiece to prevent vertical movement of the workpiece when the workpiece is positioned in the opening.

15. The fixture assembly of claim 1, wherein the holder plate comprises one or more grippers that are radially movable into and out of the opening to engage against an outer periphery of the workpiece when the workpiece is in the opening.

16. The fixture assembly of claim 2, wherein the support plate comprises a trench defining a plurality of fastener locations about the outer periphery of the workpiece, that enable angular alignment of the holder plate to the support plate.

17. A cutting system comprising the fixture assembly of claim 1 positioned with respect to a water jet cutting tool for enabling the water jet cutting tool to slit the workpiece held by the fixture assembly.

18. A method of forming a serpentine body with a water jet cutting system comprising:
positioning a workpiece in an opening of a holder plate and on top of a patterned support section that comprises a plurality of support slats interspaced with gaps such that intended cutting locations for creating slits in the workpiece are positioned directly above the gaps in the patterned support section; and
cutting a plurality of slits through the workpiece along the intended cutting locations with a water jet cutting tool of the water jet cutting system without cutting into the patterned support section to create the serpentine body from the workpiece, wherein the slats are positioned directly below uncut portions of the serpentine body after the workpiece is cut.

19. The method of claim 18, further comprising inserting a removable support element that comprises the patterned support section into a receptacle of a support plate, wherein the holder plate is secured atop the support plate.

20. The method of claim 19 further comprising:
affixing the support plate to the water jet cutting system, wherein the support plate comprises a calibration pin extending therefrom;
aligning the holder plate with respect to the support plate by inserting the calibration pin through a calibration hole in the holder plate when the holder plate is positioned atop the support plate;
calibrating a reference coordinate for the water jet cutting system with respect to the calibration pin; and
determining a location of one or more of the opening, the workpiece, the intended cutting locations, the slats, or the gaps based on the reference coordinate.
